(19) United States
(12) Patent Application Publication
(10) Pub. No.: US 2024/0213449 A1
(43) Pub. Date: Jun. 27, 2024

(54) POSITIVE ELECTRODE ACTIVE MATERIAL, LITHIUM ION SECONDARY BATTERY, AND METHOD OF MANUFACTURING POSITIVE ELECTRODE ACTIVE MATERIAL

(71) Applicant: TOYOTA JIDOSHA KABUSHIKI KAISHA, Toyota-shi Aichi-ken (JP)

(72) Inventor: Takahiko Ninomiya, Miyoshi-shi Aichi-ken (JP)

(73) Assignee: TOYOTA JIDOSHA KABUSHIKI KAISHA, Toyota-shi Aichi-ken (JP)

(21) Appl. No.: 18/544,699

(22) Filed: Dec. 19, 2023

(30) Foreign Application Priority Data
Dec. 26, 2022 (JP) 2022-208318

(51) Int. Cl. H01M 4/36; H01M 4/04; H01M 10/0525

(52) U.S. Cl. CPC H01M 4/36; H01M 4/0471; H01M 10/0525; H01M 2004/028

(57) ABSTRACT

A positive electrode active material having cycle characteristics is disclosed. The positive electrode active material of the present disclosure has a layered rock salt structure, wherein the layered rock salt structure includes as constituting elements: at least one transition metal element of Ni, Co and Mn; Mg; Li; and O, the Mg content in the positive electrode active material is 0.1 mass % or more and 5.0 mass % or less, and the layered rock salt structure has c-axis length of 13.46 Å or more and 14.20 Å or less.

### CROSS-REFERENCE TO RELATED APPLICATIONS

This application claims priority to Japanese Patent Application No. 2022-208318 filed on Dec. 26, 2022, the entire contents of which are herein incorporated by reference.

### TECHNICAL FIELD

The present application discloses a positive electrode active material, a lithium ion secondary battery, and a method of manufacturing a positive electrode active material.

### BACKGROUND ART

PTLs 1 and 2 disclose a positive electrode active material containing as constituent elements: at least one transition metal element of Ni, Co and Mn; Mg; Li; and O.

### CITATION LIST

### Patent Literature

[PTL 1] JP 2016-122546 A

[PTL 2] JP 2020-514963 A

### SUMMARY

### Technical Problem

Conventional positive electrode active material has room for improvement in terms of cycle characteristics.

### Solution to Problem

As a technique for solving the above problem, the present application discloses the following plurality of aspects.

### <Aspect 1>

A positive electrode active material having a layered rock salt structure, wherein

the layered rock salt structure includes as constituting elements:
at least one transition metal element of Ni, Co and Mn;
Mg;
Li; and
O,

the Mg content in the positive electrode active material is 0.1 mass % or more and 5.0 mass % or less, and

the layered rock salt structure has c-axis length of 13.46 Å or more and 14.20 Å or less.

### <Aspect 2>

A method of manufacturing a positive electrode active material, the method comprising:

obtaining a first mixture including at least one transition-metal element of Ni, Co and Mn and Li, and free of Mg,

firing the first mixture to obtain a precursor having a layered rock salt structure,

mixing the precursor with a Mg source to obtain a second mixture, and

firing the second mixture to obtain a positive electrode active material having a layered rock salt structure and containing 0.1 mass % or more and 5.0 mass % or less of Mg.

### <Aspect 3>

A lithium ion secondary battery comprising a positive electrode active material layer, an electrolyte layer, and a negative electrode active material layer, wherein

the positive electrode active material layer includes the positive electrode active material according to aspect 1.

### [Effects]

The positive electrode active material of the present disclosure has cycling characteristics.

### BRIEF DESCRIPTION OF DRAWINGS

FIG. 1 is a diagram for explaining Li layers, transition-metal layers and c-axis length of the crystalline structure contained in the positive electrode active material.

FIG. 2 shows an example of a flow of a method of manufacturing the positive electrode active material.

FIG. 3 schematically shows an example of the configuration of the lithium ion secondary battery.

### DESCRIPTION OF EMBODIMENTS

Hereinafter, a positive electrode active material and a method of manufacturing the same according to an embodiment, and a lithium ion secondary battery or the like using the positive electrode active material will be described.

### 1. Positive Electrode Active Material

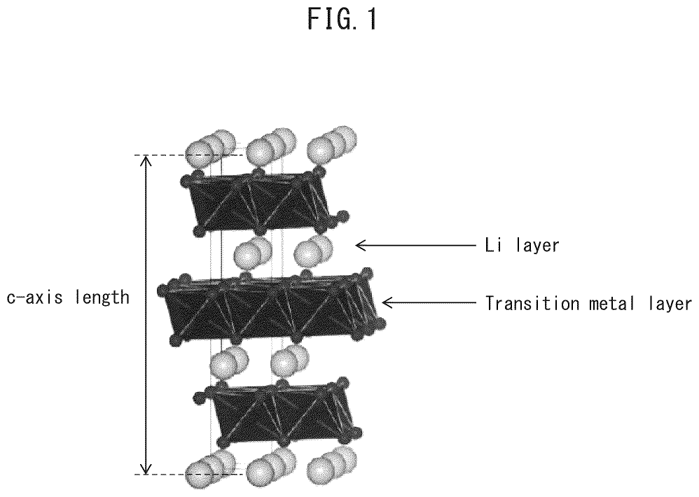

With reference to FIG. 1, an embodiment of the positive electrode active material of the present disclosure will be described. The positive electrode active material of the present disclosure has a layered rock salt structure. The layered rock salt structure includes as constituting elements: at least one transition metal element among Ni, Co and Mn; Mg; Li; and O. The Mg content in the entire positive electrode active material is 0.1 mass % or more and 5.0 mass % or less. The layered rock salt structure has c-axis length of 13.46 Å or more and 14.20 Å or less.

### 1.1 Chemical Composition

The positive electrode active material of the present disclosure includes at least: at least one transition-metal elements selected from Mn, Ni and Co; Mg; Li; and O as constituent elements. When the constituent elements include at least Ni, Mg, Li, and O, or when the constituent elements include at least Mn, Mg, Li, and O, in particular when the constituent elements include at least: Ni; at least one of Mn and Co; Mg; Li; and O, or when the constituent elements include at least: Mn; at least one of Ni and Co; Mg; Li and O; in particular when the constituent elements include at least Li, Mg, Mn, Ni, Co and O, higher performance is easily ensured. In addition, the positive electrode active material of the present disclosure may contain other impurity elements.

The positive electrode active cathode material of the present disclosure includes Mg as described above. It is considered that by the presence of a Mg having an ionic radius close to that of Li and an ionic radius larger than that of the transition metal in Li layer of the crystal structure of the positive electrode active material, the cationic mixing (moving to Li layer) of the transition metal is suppressed, and the distortion of the crystal structure is also suppressed, whereby the crystal structure is stabilized and the cycling characteristic is also improved. In the positive electrode active material of the present disclosure, if the amount of Mg is too small, it is difficult to obtain a stabilizing effect of a crystalline structure. Further, if the amount of Mg is too large, the stabilizing effect of the crystalline structure is obtained, but the amount of Li is relatively reduced, and the capacity tends to decrease. In this regard, in some embodiments, the positive electrode active material of the present disclosure contains Mg in an amount of 0.1 mass % or more and 5.0 mass % or less. Thus, both the stability of the crystal structure and the high capacity can be achieved. The amount of Mg in the entire positive electrode active material may be 0.5 mass % or more, and may be 4.0 mass % or less, 3.0 mass % or less, or 2.0 mass % or less.

The specific chemical composition of the positive electrode active material of the present disclosure is not particularly limited as long as the positive electrode active material includes the constituent elements described above, the above Mg amount is satisfied, and the crystalline structure described below is maintained. The positive electrode active material of the present disclosure may have a chemical composition of, for example, LiₐMgₓMn_{b}Ni_{c}Co_{d}O_{2±α} (here, 0.95≤a≤1.05, 0≤b≤1.00, 0≤c≤1.00, 0≤d≤1.00, 0.95≤b+c+d≤1.05, x is the amount of which Mg in the entire positive electrode active material is 0.1 mass % or more and 5.0 mass % or less). Here, it may be 0≤b<0.50, 0.50≤c≤1.00, and 0≤d<0.50, or it may be 0.50≤b≤1.00, 0≤c<0.50, 0≤d<0.50, or it may be 0≤b<0.50, 0≤<0.50, and 0.50≤d≤1.00. Note that the chemical composition of the positive electrode active material can be specified by various elemental analysis.

### 1.2 Crystal Structure

The positive electrode active material of the present disclosure has a layered rock salt structure (α-NaFeO₂ type layered rock salt structure) as a crystal structure. Specifically, it has a layered structure of O3 type comprising Li layers and transition-metal layers as shown in FIG. 1. Here, when Mg is inserted into the transition metal layer of the layered rock salt structure, since the ionic radius of Mg is larger than that of Mn, Ni and Co, it is considered that the distortion is generated in the octahedral structure of the transition metal layer, consequently, the layered rock salt structure is destabilized, whereby the cyclic property is considered to become insufficient. On the other hand, when Mg is inserted into Li layers, it is considered that the above-mentioned distortion is difficult to occur, and the cationic mixing is also difficult to occur, so that the layered rock salt structure is stabilized, and the cycling characteristic is improved. According to the findings of the present inventor, when Mg is inserted into the Li layer, c-axis length (see FIG. 1) becomes smaller than when Mg is inserted into the transition-metal layer. More specifically, when the c-axis length of the layered rock salt structure containing no Mg is used as a reference, the c-axis length of the layered rock salt structure in which Mg is inserted into Li layer becomes smaller than the reference, and the c-axis length of the layered rock salt structure in which Mg is inserted into the transition-metal layer becomes larger than the reference. Further, the larger Mg inserted into Li layers, the smaller the c-axis length.

As described above, the positive electrode active material of the present disclosure contains 0.1 mass % or more and 5.0 mass % or less of Mg, and the c-axis length of the layered rock salt structure may be a predetermined range depending on the amount of Mg. Specifically, in the positive electrode active material of the present disclosure, the c-axis length of the layered rock salt structure is 13.46 Å or more and 14.20 Å or less. When the c-axis length is lower than the lower limit, Li content is relatively reduced because the amount of Mg inserted into Li layers becomes excessive, so that the capacity tends to decrease. When the c-axis length exceeds the upper limit, the amount of Mg inserted into Li layers is insufficient, or the amount of Mg inserted into the transition-metal layer is increased, so that it is difficult to obtain a stabilizing effect of the crystal structure. The c-axis length of the layered rock salt structures in the active positives of the present disclosure may be 13.50 Å or more, 13.60 Å or more, 13.70 Å or more or 13.84 Å or more, and may be 14.15 Å or less, or 14.11 Å or less. Note that the crystal structure of the positive electrode active material and its c-axis length can be specified by X-ray diffraction measurement or the like.

### 1.3 Other

The shape of the positive electrode active material of the present disclosure is not particularly limited, and may be, for example, particulate. The positive electrode active material particles may be solid particles, or may be hollow particles, or may be those having a void. The positive electrode active material particles may be primary particles or secondary particles in which a plurality of primary particles are aggregated. In some embodiments, each of the primary particles of the positive electrode active material particles has the above-described chemical composition and crystal structure. A mean particle diameter (D50) of the positive active material particle may be, for example, 1 nm or more, 5 nm or more or 10 nm or more, and may be 500 μm or less, 100 μm or less, 50 μm or less or 30 μm or less. The mean particle diameter D50 as referred to in the present application is the particle diameter (median diameter) at an integrated value of 50% in the particle size distribution on a volume basis determined by a laser diffraction/scattering method.

### 2. Method of Producing Positive Electrode Active Material

As described above, the positive electrode active material of the present disclosure is obtained by inserting Mg into Li layers of the layered rock salt structure. According to the findings of the present inventor, whether Mg is inserted into the Li layer or Mg is inserted into the transition-metal layer can be controlled by, for example, a timing at which Mg is added when a positive electrode active material is synthesized. For example, the Li layer of the layered rock salt structure can be inserted with Mg by obtaining a composite oxide (precursor) containing Li and a transition-metal and having a layered rock salt structure without Mg and heating (firing) a Mg source together with the composite oxide.

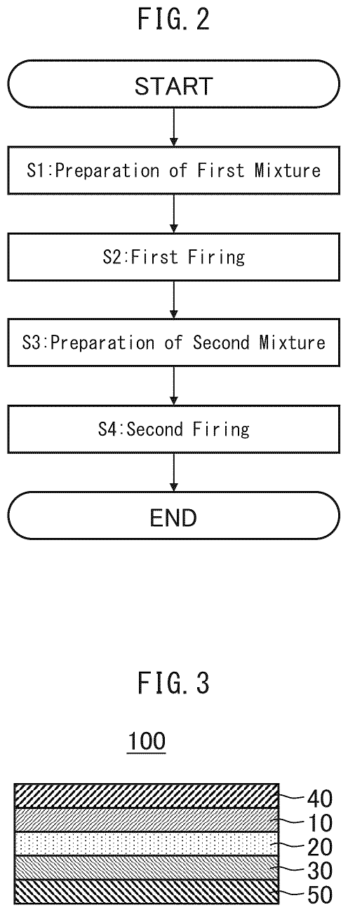

FIG. 2 shows an example of a flow of the method of manufacturing a positive electrode active material of the present disclosure. As shown in FIG. 2, the one embodiment of method of manufacturing the positive electrode active material of the present disclosure comprises:

S1: obtaining a first mixture comprising a transition-metal element of at least one of Ni, Co and Mn and Li, and free of Mg,

S2: firing the first mixture to obtain a precursor having a layered rock salt structure,

S3: mixing the precursor with a Mg source to obtain a second mixture, and

S4: firing the second mixture to obtain a positive electrode active material having a layered rock salt structure and containing 0.1 mass % or more and 5.0 mass % or less of Mg.

### 2.1 Preparing First Mixture

In the step S1, a first mixture comprising at least one transition-metal element of Ni, Co and Mn and Li is obtained. The first mixture does not contain Mg. The first mixture may be obtained, for example, by mixing a transition-metal source and a Li source. The transition metal source may be, for example, various salts such as sulphate and carbonate, or may be a hydroxide or an oxide. The transition metal source may be, for example, a mixture of a plurality of types of transition metal sources. The plurality of types of transition metal sources may be mixed in a liquid phase or may be mixed in a solid phase. For example, the transition metal source may be one obtained as a precipitate by crystallization after dissolving a plurality of types of transition metal sources in a solvent. The Li source may be, for example, various salts such as sulphate and carbonate, or may be a hydroxide or an oxide. The transition-metal source and the Li source may be mixed in a liquid phase or may be mixed in a solid phase. For example, the transition-metal source and the Li source may be mixed using a mortar, a ball mill, or the like. The mixing ratio of the transition-metal source and the Li source in the first mixture may be appropriately determined depending on the chemical composition of the positive electrode active material as the final product.

### 2.2 First Firing

In the step S2, the first mixture is firing (heating) to obtain a precursor having a layered rock salt structure. The firing condition may be any condition that the layered rock salt structure can be obtained. The firing atmosphere may be, for example, an oxygen-containing atmosphere such as an air atmosphere or an oxygen atmosphere. The firing temperature may be, for example, 500° C. or higher and 1100° C. or less. The firing time may be, for example, 1 hour or more and 20 hours or less. Various firing furnace (muffle furnace, etc.) may be used as the firing technique.

### 2.3 Preparing Second Mixture

In the step S3, the precursor and a Mg source are mixed to obtain a second mixture. The precursor may be crushed prior to mixing the precursor and Mg source. For crushing, various pulverizers (such as jet mills) may be used. The Mg source may be, for example, various salts such as sulphate and carbonate, or may be a hydroxide or an oxide. The precursor and the Mg source may be mixed in a liquid phase or may be mixed in a solid phase. For example, the precursor and the Mg source may be mixed using a mortar, a ball mill, or the like.

### 2.4 Second Firing

In the step S4, the second mixture is firing (heating) to obtain a positive electrode active material having a layered rock salt structure and containing 0.1 mass % or more and 5.0 mass % or less of Mg. The firing condition may be any condition that the layered rock salt structure is maintained. The firing atmosphere in the step S4 may be the same as or different from the firing atmosphere in the step S2, and may be, for example, an oxygen-containing atmosphere such as an air atmosphere or an oxygen atmosphere. The firing temperature in the step S4 may be the same as or different from the firing temperature in the step S2, and may be, for example, 800° C. or more and 1100° C. or less. The firing time in the step S4 may be the same as or different from the firing time in the step S2, and may be, for example, 1 hour or more and 20 hours or less. Various firing furnace (muffle furnace, etc.) may be used as the firing technique. The positive electrode active material obtained by the step S4 may be crushed by various pulverizers (such as a jet mill)

### 3. Lithium Ion Secondary Battery

The technique of the present disclosure also has an aspect as a lithium ion secondary battery. FIG. 3 schematically shows a configuration of a lithium ion secondary battery 100 according to an embodiment. As shown in FIG. 3, the lithium ion secondary battery 100 of the present disclosure has the positive electrode active material layer 10, the electrolyte layer 20, and the negative electrode active material layer 30. The positive electrode active material layer 10 includes the positive electrode active material of the present disclosure described above.

### 3.1 Positive Electrode Active Material Layer

The positive electrode active material layer 10 includes a positive electrode active material, and may optionally include an electrolyte, a conductive aid, a binder, various additives, and the like. The content of each of the positive electrode active material, the electrolyte, the conductive aid, the binder, and the like in the positive electrode active material layer 10 may be appropriately determined according to the battery performance. For example, the content of the positive electrode active material may be 40 mass % or more, 50 mass % or more, or 60 mass % or more, and may be 100 mass % or less or 90 mass % or less, taking the entire positive electrode active material layer 10 (entire solid content) as 100 mass %. The shape of the positive electrode active material layer 10 is not particularly limited, and may be, for example, a sheet-like positive electrode active material layer 10 having a substantially planar surface. The thickness of the positive electrode active material layer 10 is not particularly limited, and may be, for example, 0.1 μm or more or 1 μm or more, and may be 2 mm or less or 1 mm or less.

The positive electrode active material layer 10 may include only the positive electrode active material of the present disclosure described above as the positive electrode active material. Alternatively, the positive electrode active material layer 10 may include a different type of positive electrode active material (other positive electrode active material) in addition to the positive electrode active material of the present disclosure described above. For example, when the entire positive electrode active material contained in the positive electrode active material layer 10 is set to 100 mass %, the content of the positive electrode active material of the present disclosure described above may be 50 mass % or more, 60 mass % or more, 70 mass % or more, 80 mass % or more, 90 mass % or more, 95 mass % or more, or 99 mass % or more. The surface of the positive electrode active material may be coated with a protective layer containing a lithium ion conductive oxide, whereby a reaction between the positive electrode active material and sulfide (e.g., a sulfide solid electrolyte or the like to be described later) or the like is easily suppressed. The lithium-ion conductive oxide may be a Li containing complex oxide containing at least one element selected from B, C, Al, Si, P, S, Ti, Zr, Nb, Mo, and W. The coverage ratio (area ratio) of the protective layer may be, for example, 70% or more, 80% or more, or 90% or more. The thickness of the protective layer may be, for example, 0.1 nm or more or Inm or more, and may be 100 nm or less or 20 nm or less.

The electrolyte that may be contained in the positive electrode active material layer 10 may be a solid electrolyte, a liquid electrolyte (electrolytic solution), or a combination thereof. Only one kind of electrolytes may be used alone, or two or more kinds thereof may be used in combination. As the solid electrolyte, a known solid electrolyte of a lithium ion secondary battery may be used. The solid electrolyte may be an inorganic solid electrolyte or an organic polymer electrolyte. In particular, the inorganic solid electrolyte has ionic conductivity and heat resistance. The inorganic solid electrolyte may be, for example, at least one selected from an oxide solid electrolyte, a sulfide solid electrolyte, a hydride solid electrolyte, a halide solid electrolyte, and the like. The solid electrolyte may be amorphous or crystalline. The solid electrolyte may be, for example, particulate. The electrolytic solution may be an aqueous electrolytic solution or a nonaqueous electrolytic solution. The composition of the electrolytic solution may be the same as that well known as the composition of the electrolytic solution of the lithium ion secondary battery. For example, the electrolytic solution may be a solution obtained by dissolving a lithium salt in a carbonate-based solvent at a predetermined concentration.

Examples of the conductive aid which may be contained in the positive electrode active material layer 10 include carbon materials such as acetylene black (AB), Ketjen black (KB), carbon black (CB), carbon nanotubes (CNT), vapor phase carbon fibers (VGCF) and carbon nanofibers (CNF); and metallic materials such as nickel, aluminum and stainless steel. The shape and size of the conductive aid are not particularly limited. Only one kind of the conductive auxiliary agents may be used alone, or two or more kinds thereof may be used in combination.

Examples of the binder which may be contained in the positive electrode active material layer 10 include a butadiene rubber (BR) based binder, a butylene rubber (IIR) based binder, an acrylate butadiene rubber (ABR) based binder, a styrene butadiene rubber (SBR) based binder, a polyvinylidene fluoride (PVdF) based binder, a polytetrafluoroethylene (PTFE) based binder, a polyimide (PI) based binder, a carboxy methylcellulose (CMC) based binder, and a polyacrylic acid (PAA) based binder. Only one kind of binders may be used alone, or two or more kinds thereof may be used in combination.

### 3.2 Electrolyte Layer

The electrolyte layer 20 includes at least an electrolyte. When the lithium ion secondary battery 100 is a solid state battery (a battery including a solid electrolyte, which may be a battery in which a liquid electrolyte is partially used in combination, or may be an all-solid battery that does not include a liquid electrolyte), the electrolyte layer 20 may include a solid electrolyte, and may further optionally include a binder or the like. In this case, the content of the solid electrolyte, the binder, and the like in the electrolyte layer 20 is not particularly limited. On the other hand, when the lithium ion secondary battery 100 is an electrolytic solution battery, the electrolyte layer 20 may include an electrolytic solution, and may further include a separator or the like for holding the electrolytic solution and preventing contact between the positive electrode active material layer 10 and the negative electrode active material layer 30 The thickness of the electrolyte layer 20 is not particularly limited, and may be, for example, 0.1 μm or more or 1 μm or more, and may be 2 mm or less or 1 mm or less. The electrolyte and the binder contained in the electrolyte layer 20 may be appropriately selected from those exemplified as those which may be included in the positive electrode active material layer described above. The separator may be any separator commonly used in lithium ion secondary batteries, and examples thereof include a separator made of a resin such as polyethylene (PE), polypropylene (PP), polyester, or polyamide. The separator may have a single layer structure or a double layer structure. The separator may be made of a nonwoven fabric such as a cellulose nonwoven fabric, a resin nonwoven fabric, or a glass fiber nonwoven fabric.

### 3.3 Negative Electrode Active Material Layer

The negative electrode active material layer 30 includes at least a negative electrode active material, and may further optionally include an electrolyte, a conductive aid, a binder, various additives, and the like. The content of each of the negative electrode active material, the electrolyte, the conductive aid, the binder, and the like in the negative electrode active material layer 30 may be appropriately determined according to the battery performance. The shape of the negative electrode active material layer 30 is not particularly limited, and may be, for example, a sheet-like negative electrode active material layer having a substantially planar surface. The thickness of the negative electrode active material layer 30 is not particularly limited, and may be, for example, 0. 1 μm or more or 1 μm or more, and may be 2 mm or less or 1 mm or less. As the negative electrode active material, for example, a silicon-based active material such as Si, a Si alloy, or silicon oxide; a carbon-based active material such as graphite or hard carbon; various oxide-based active materials such as lithium titanate; metallic lithium or lithium alloy, and the like can be adopted. Only one kind of negative electrode active materials may be used alone, or two or more kinds thereof may be used in combination. The electrolyte, the conductive aid, and the binder which may be included in the negative electrode active material layer 30 may be, for example, appropriately selected from those exemplified as those which may be included in the positive electrode active material layer 10 described above.

### 3.4 Other

As shown in FIG. 3, the lithium ion secondary battery 100 may be provided with the positive electrode collector 40 electrically connected to the aforementioned positive active material layer 10, and the negative electrode collector 50 electrically connected to the aforementioned negative active material layer 30. As the configuration of the current collector, any known configuration may be employed. In addition, the lithium ion secondary battery 100 may have a general configuration as a secondary battery in addition to the above-described configuration, for example, a tab, a terminal, or the like. In addition, the lithium ion secondary battery 100 may be one in which each of the above-described configurations is housed inside an exterior body. Any known exterior body of a battery can be employed as the exterior body of the lithium ion secondary battery 100. In addition, a plurality of batteries 100 may be optionally electrically connected and optionally superimposed to form a battery assembly. The shape of the lithium-ion secondary battery 100 may be, for example, coin-type, laminate-type, cylindrical, or square-type. The lithium ion secondary battery 100 may be manufactured through, for example, forming each of the above-described layers in a dry or wet manner, or the like.

4. Vehicles having Lithium Ion Secondary Batteries

The lithium ion secondary battery of the present disclosure has cycling characteristics. Such a lithium ion secondary battery having performance can be suitably used in at least one type of vehicle selected from, for example, a hybrid electric vehicle (HEV), a plug-in hybrid electric vehicle (PHEV), and an battery electric vehicle (BEV). In other words, the technique of the present disclosure includes a vehicle having a lithium ion secondary battery, wherein the lithium ion secondary battery has a positive electrode active material layer, an electrolyte layer, and a negative electrode active material layer, and the positive electrode active material layer includes a positive electrode active material of the present disclosure.

### EXAMPLES

Hereinafter, the technique of the present disclosure will be described in further detail with reference to Examples, but the technique of the present disclosure is not limited to the following Examples.

### 1. Preparation of the Positive Electrode Active Material

### 1.1 Example 1

Through the steps S1 to S4 shown in FIG. 2, a positive electrode active material is prepared. In detail, as follows.

Step S1 (Preparation of First Mixture): In ion-exchanged water, NiSO₄, CoSO₄ and MnSO₄ as a transition-metal source were dissolved to obtain a raw material dissolving solution. Ni:Co:Mn was set at 8:1:1 (atm %). The concentration of the raw material dissolving solution was set to 30 mass %. Subsequently, a predetermined amount of an aqueous NH₃ solution was added into the reactor vessel, and the mixture was nitrogen-substituted with stirring by a stirrer. Subsequently, NaOH was added into the reactor vessel to adjust pH to alkaline. Subsequently, while controlling pH of the solutions in the reaction vessel to be constant, the raw material dissolving liquid and NH₃ were dropped here to precipitate the transition-metal hydroxide. Subsequently, the transition metal hydroxide was collected by filtration, and ion-exchanged water was added to wash. Subsequently, the material was filtered to collect the washed transition metal hydroxide. Subsequently, the transition metal hydroxide was dried at 120° C. for 16 hours. Subsequently, the first mixtures were obtained by mixing the dried transition-metal hydroxides with Li₂CO₃ as a Li source in a mortar.

Step S2 (First Firing): In a muffle oven, the first mixture was fired to obtain precursors with a layered rock salt structure. The firing atmosphere was an oxygen atmosphere, the firing temperature was 600° C., and the firing time was 10 hours.

Step S3 (Preparation of Second Mixture): The obtained precursor was crushed by jet-milling, and then the precursor and Mg(OH)₂ as a Mg source were mixed in a mortar to obtain a second mixture.

Step S4 (second firing): In a muffle oven, the second mixture was fired to obtain a positive electrode active material having a layered rock salt structure. The firing atmosphere was an oxygen atmosphere, the firing temperature was 900° C., and the firing time was 10 hours. Thereafter, the positive electrode active material was crushed by a jet mill to obtain a positive electrode active material according to Example 1. The positive electrode active material according to Example 1 contains Ni, Co and Mn in a molar ratio of Ni:Co:Mn=8:1:1, and contains Li, Mg, and O. Further, the content of Mg in the positive electrode active material was 1.0 mass %.

### 1.2 Examples 2 to 5, Comparative Examples 1 and 5

A positive electrode active material was obtained in the same manner as in Example 1, except that the blending ratio of Mg source to the precursors was changed in the step S3. All of the positive electrode active materials according to Examples 2 to 5 and Comparative Example 5 contained Ni, Co and Mn in a molar ratio of Ni:Co:Mn=8:1:1, and contained Li, Mg, and O. In addition, the content of Mg contained in the positive electrode active material according to Example 2 was 0.1 mass %, Example 3 was 0.5 mass %, Example 4 was 2.0 mass %, Example 5 was 5.0 mass %, Comparative Example 1 was 0 mass % (no Mg source added), and Comparative Example 5 was 7.0 mass %.

### 1.3 Comparative Example 2

In the step S1, by adding Mg(OH)₂ as a Mg source at the timing of performing crystallization of the raw material solution, a mixed hydroxide of the transition metal hydroxide and Mg(OH)₂ was obtained, and then the mixed hydroxide and Li source were mixed to obtain a first mixture containing the transition metal and Li and Mg. The first mixture was fired under the same conditions as those of the second firing of Example 1 to obtain a positive electrode active material according to Comparative Example 2. The positive electrode active material according to Comparative Example 2 contained Ni, Co and Mn in a molar ratio of Ni:Co:Mn=8:1:1, and contained Li, Mg, and O. The content of Mg in the positive electrode active material according to Comparative Example 2 was 1.0 mass %.

### 1.4 Comparative Example 3

In the step S1, together with the transition metal hydroxide and Li source, Mg(OH)₂ was mixed to obtain a first mixture containing a transition metal, Li and Mg, and then fired under the same conditions as those of the second firing of Example 1 to obtain a positive electrode active material according to Comparative Example 3. The positive electrode active material according to Comparative Example 3 contained Ni, Co and Mn in a molar ratio of Ni:Co:Mn=8:1:1, and contained Li, Mg, and O. The content of Mg in the positive electrode active material according to Comparative Example 3 was 1.0 mass %.

### 1.5 Comparative Example 4

Without performing the step S2 and the step S3, the first mixture obtained in the same manner as in Example I was fired under the same conditions as in the second firing of Example 1, followed by adding Mg(OH)₂ to the fired product to obtain a positive electrode active material according to Comparative Example 4. The positive electrode active material according to Comparative Example 4 contained Ni, Co and Mn in a molar ratio of Ni:Co:Mn=8:1:1, and contained Li, Mg, and O (provided that Mg is present as Mg(OH) ₂) The content of Mg in the positive electrode active material according to Comparative Example 4 was 1.0 mass %.

### 2. X-Ray Diffraction Measurement

X-ray diffraction measurement of the positive electrode active material was performed by an X-ray diffraction measuring device (manufactured by Rigaku Co., Ltd., SmartLab), and its X-ray diffraction peak was confirmed. The X-ray diffraction measurement was performed at the condition of angle (2θ): 10 to 120° and speed: 10°/min. The half-value was automatically calculated using the attached software (SmartLab Studio II). The c-axis is calculated using analysis software (fullprof) by fitting the diffraction pattern (Rietveld analysis). The X-ray diffraction peak was confirmed for the positive electrode active material of each of the examples and comparative examples, and it is confirmed that all of them had a diffraction peak assigned to a layered rock salt structure of α-NaFeO₂ type, and had the layered rock salt structure as a main phase.

### 3. Preparation of the Test Cell

The positive electrode active material described above, acetylene black as a conductive aid, and PVdF as a binder were mixed with solvents so as to be 88:10:2 (mass-ratio) to obtain a positive electrode slurry. Using a film applicator (manufactured by All Good Co., Ltd.), the positive electrode slurry was coated on a current collector foil and dried at 80° C. for 5 minutes to obtain a positive electrode. On the other hand, natural graphite as a negative electrode active material and SBR and CMC as binders were mixed with solvents to obtain a negative electrode slurry. Using a film applicator (manufactured by All Good Co., Ltd.), the negative electrode slurry was coated on a current collector foil and dried at 80° C. for 5 minutes to obtain a negative electrode. The positive electrode and the negative electrode described above were wound in a cylindrical shape together with a separator and were housed in a case together with an electrolytic solution to prepare a cylindrical cell. As an electrolytic solution, a solution obtained by dissolving 1M LiPF₆ in a solvent composed of EC/DMC/EMC=3/4/4 (volume %) was used.

### 4. Evaluation of Cycle Characteristics

For the prepared test cell, a charge/discharge cycle test was performed for 100 cycles in 1C, 1.5-4.1V, and the discharge capacity of 1CCCV1.5-4.1V before and after the test was measured. The capacity retention ratio after 100 cycles was calculated based on the following equation.

$$Capacity retention after 100 cycles = ( Capacity after 100 cycles ) / ( Initial capacity )$$

### 5. Evaluation Results

Table 1 below shows the chemical composition (Mg amount) of the positive electrode active material, the crystal structure (c-axis length, Li occupancy ratio in Li layer), the initial capacity of the test cell (theoretical capacity ratio), and the capacity retention after 100 cycles for each of the examples and comparative examples.

TABLE 1

| | | | Li | ratio of | Capacity |
|---|---|---|---|---|---|
| | | | occupancy | initial | retention |
| | Mg | c-axis | ratio in | capacity to | after |
| | content | length | Li layer | theoretical | 100 cycles |
| | (mass %) | (Å) | (%) | capacity (%) | (%) |
| Comp. Ex. 1 | 0 | 14.21 | 98.8 | 100 | 70 |
| Comp. Ex. 2 | 1.0 | 15.10 | 97.2 | 99 | 68 |
| Comp. Ex. 3 | 1.0 | 14.57 | 97.7 | 100 | 69 |
| Comp. Ex. 4 | 1.0 | 14.21 | 98.9 | 100 | 70 |
| Ex. 1 | 1.0 | 14.02 | 98.5 | 101 | 76 |
| Ex. 2 | 0.1 | 14.11 | 98.7 | 100 | 73 |
| Ex. 3 | 0.5 | 14.08 | 98.6 | 100 | 75 |
| Ex. 4 | 2.0 | 13.84 | 98.2 | 102 | 76 |
| Ex. 5 | 5.0 | 13.46 | 97.9 | 100 | 78 |
| Comp. Ex. 5 | 7.0 | 13.38 | 97.7 | 94 | 80 |

From the results shown in Table 1, it can be seen that:
(1) In Comparative Examples 2 and 3, the c-axis length in the layered rock salt structure of the positive electrode active material increased as compared with Comparative Example 1. This means that Mg was inserted into the transition-metal layers of the layered rock salt structure. It is considered that in Comparative Examples 2 and 3, distortion is generated by the Mg with large ionic radii inserted into the transition metal layer of the layered rock salt structure, also Li occupancy in Li layer is also reduced by cationic mixing, as a result, the cycling characteristic is lowered than in Comparative Example 1.
(2) Comparative Example 4 is obtained by adding Mg(OH)₂ after firing of the positive electrode active material, but in this case, the c-axis length of the layered rock salt structure is not different from that of Comparative Example 1, and there is no change in the cycling characteristic.

(3) In Examples 1 to 5, the c-axis length in the layered rock salt structure of the positive electrode active material was reduced as compared with Comparative Example 1. This means that Mg was inserted into Li layers of the layered rock salt structure. It is considered that in Examples 1 to 5, since the distortion of the crystal structure and the cationic mixing as in Comparative Examples 2 and 3 are suppressed and the stabilizing effect of the crystal structure due to Mg is obtained, as a result, the cycling characteristic is improved more than that of Comparative Example 1.
(4) In Comparative Example 5, since the amount of Mg in the positive electrode active material was excessive, the amount of Li decreased relatively, and the capacity decreased.

### 6. Summary

From the above examples, it can be said that a positive electrode active material with the following (1) to (4) has cycling properties.
(1) The positive electrode active material has a layered rock salt structure,
(2) elements constituting the layered rock salt structure contains at least one transition metal element of Ni, Co and Mn; Mg; Li; and O,
(3) an amount of Mg in the entire positive electrode active material is 0.1 mass % or more and 5.0 mass % or less, and
(4) c-axis length of the layered rock salt structure is 13.46 Å or more and 14.20 Å or less

### REFERENCE SIGNS LIST

10 Positive electrode active material layer

20 Electrolyte layer

30 Negative electrode active material layer

40 Positive electrode current collector

50 Negative electrode current collector

100 Lithium ion secondary battery

1. A positive electrode active material having a layered rock salt structure, wherein
the layered rock salt structure includes as constituting elements:
at least one transition metal element of Ni, Co and Mn;
Mg;
Li; and
O,
the Mg content in the positive electrode active material is 0.1 mass % or more and 5.0 mass % or less, and
the layered rock salt structure has c-axis length of 13.46 Å or more and 14.20 Å or less.

2. A method of manufacturing a positive electrode active material, the method comprising:
obtaining a first mixture including at least one transition-metal element of Ni, Co and Mn and Li, and free of Mg,
firing the first mixture to obtain a precursor having a layered rock salt structure,
mixing the precursor with a Mg source to obtain a second mixture, and
firing the second mixture to obtain a positive electrode active material having a layered rock salt structure and containing 0.1 mass % or more and 5.0 mass % or less of Mg.

3. A lithium ion secondary battery comprising a positive electrode active material layer, an electrolyte layer, and a negative electrode active material layer, wherein the positive electrode active material layer includes the positive electrode active material according to claim 1.
